(19) United States
(12) Patent Application Publication
(10) Pub. No.: US 2003/0200141 A1
(43) Pub. Date: Oct. 23, 2003

(54) Customer loyalty program

(76) Inventor: Sharon K. Robison, Julesbury, CO (US)

Correspondence Address: Barry L. Kelmachter, BACHMAN & LaPOINTE, P.C., Suite 1201, 900 Chapel Street, New Haven, CT, 06510-2802, US

(21) Appl. No.: 10/127,230

(22) Filed: Apr. 19, 2002

(51) Int. Cl. G06F 17/60

(52) U.S. Cl. 705/14

(57) ABSTRACT

The present invention relates to a method for rewarding customers of a business. The method broadly comprises establishing an account for the customer, awarding points to the customer account based on customer purchases, inviting the customer to attend an event at a particular site, and awarding additional points to the customer account when the customer attends the event. The method of the present invention also awards bonus points to the customer account if the customer brings another individual and the another individual performs a particular act.

### BACKGROUND OF THE INVENTION

The present invention generally relates to a customer loyalty program to be run by a business and, in particular, to a method for rewarding customers of a business. For many years now, businesses such as airlines, hotels, retail stores, and rental cars have used reward programs to maintain their customer base and to attract new customers. In many of these programs, a customer earns points for undertaking some activity, such as taking flights on a particular airline or a companion airline. In some programs, points may be earned by simply charging purchased items to a particular type of credit card. The points which are earned in these programs can be redeemed for various goods and services. As more and more of these programs come into existence, there becomes a need for new and innovative programs for maintaining the loyalty of one's customer base as well as for enhancing the customer base.

### SUMMARY OF THE INVENTION

Accordingly, it is an object of the present invention to provide a new method for rewarding customers of a business.

It is a further object of the present invention to provide a method as above which has the ability to attract new customers and enhance business revenues.

The foregoing objects are attained by the method of the present invention.

In accordance with the present invention, a method for rewarding a customer is provided. The method broadly comprises the steps of establishing an account for a customer, awarding points to the customer account based on customer purchases, inviting the customer to attend an event at a particular site, and awarding additional points to the customer account when the customer attends the event. The method of the present invention also awards bonus points to the customer account if the customer brings a another individual to the event and the another individual performs a particular act, such as joining a customer loyalty program operated by the business or by signing up for a particular credit card.

Other details of the customer reward method of the present invention, as well as other objects and advantages attendant thereto, are set forth in the following detailed description.

### DETAILED DESCRIPTION OF THE PREFERRED EMBODIMENT(S)

As previously mentioned, the present invention relates to a customer loyalty program to be run by a business such as retail business. The program of the present invention allows the business to invite selected customers to special events, such as the opening of a new retail store, and reward those customers for their attendance, as well as for, bringing potential customers.

The method of the present invention begins with customers for whom an account has been established and who have been awarded points in their accounts based on purchases made by the customer. Such customers typically have a loyalty credit card, i.e. a credit card issued by a bank to which purchases may be charged, and/or a membership card, either or both of which are associated with a number for their account.

To enhance the relationship between certain customers and the business, it is desirable to invite the customers to special events put on by the business on special dates. These special events may include the opening of a new store, a special promotional sale to be conducted by the business at a particular location, a special event such as a seminar or show to be conducted at a particular location, etc. While one could invite all customers enrolled in the loyalty program, this is not the most cost effective approach. Hence, it is more desirable to select customers to be invited to the event. The selection criteria for inviting only certain customers can include any of a number of factors. For example, only customers who live within a particular distance from the event may be invited. Additionally, or alternatively, only customers who have active accounts, i.e. frequent purchasers, or customers who conducted a minimum number of transactions with the business, or customers who have purchased a minimum level of goods over a particular period of time may be invited.

Once the customer selection has been completed and a list of customers to be invited has been generated, any suitable means known in the art may be used to issue the invitations to attend the event. For example, if the customer has a computer and has provided the business with his/her e-mail address, the invitation may be issued over the Internet. Alternatively, the invitation may be issued through a personal telephone call. Still further, a selected customer may be invited to attend the event by direct mail via the issuance of a written invitation or flier. Direct mail may be regular postal services or special delivery services such as UPS or Federal Express. If desired, the invitation may be included in a catalog or other promotional piece which is mailed or otherwise distributed to the customer. The invitation may include certain purchase incentives for the customer, such as discount coupons, and/or a listing of certain things for which the customer would receive bonus points to his accounts. For example, if the customer brings a friend and the friend performs some act, such as signing up for a credit card and being accepted, the customer's account will be awarded with bonus points.

Once the customer has received the invitation to the event, to receive additional points in his account, the customer must attend the event. After the customer has identified himself/herself to an operator of the business, such as by stopping by a courtesy desk, the customer's account will be awarded additional points on-site. Additional points may be awarded on-site to the customer's account if the customer brings another individual, such as a friend, and that individual performs a particular act, such as signing up for a credit card or enrolling in the loyalty program run by the business.

Once the individual brought to the event performs the particular act, an account is created for them. Points may be awarded to this account either immediately or when the individual's application is processed and approved. For example, if the particular act is to sign up for a credit card, the points would not be awarded to the individual's account until such time as the individual passes a credit check. If the individual is not approved, the new account for that individual may be cancelled.

Further, the customer's account may be awarded with further bonus points for purchases made by the customer during the event. Special discounts may be offered to the customer for attending the event.

To further enhance the relationship between the business and the customer, special programs may be made available to the customer. For example, if the business is a retail store which sells fishing equipment, then the customer may be invited to attend a seminar on fly fishing or may be invited to test new equipment, while he/she is attending the event. Still further, special programs may be conducted for the customer's family and children. For example, contests for the children may be run at the event. Also, drawings for prizes may be conducted periodically for both the customers and the individual(s) that they bring.

Other incentives which can be offered to the customer for attending the event may include free transportation from a designated location to the site of the event, special accommodation rates at a lodging facility near the site of the event, the provision of one or more special meals during the event, and/or the provision of a hospitality suite at the site of the event.

While the method for rewarding loyal customers described herein is directed to having customers attend a particular event, selected customers may have points awarded to their accounts for things other than attending the event. An alternative way for the customer to be awarded points may include making purchases by facsimile or by telephone.

As can be seen from the foregoing discussion, a customer loyalty program has been developed which allows a business to enhance its relationship and good will with its customer base. The program further allows the business to grow its customer base by incenting its current customer base to introduce new people to the business and to its loyalty program.

It is apparent that there has been provided in accordance with the present invention a customer reward program which fully satisfies the objects, means, and advantages set forth hereinbefore. While the present invention has been described in the context of specific embodiments thereof, other alternatives, modifications, and variations will become apparent to those skilled in the art having read the foregoing detailed description. Accordingly, it is intended to embrace those alternatives, modifications, and variations as fall within the broad scope of the appended claims.

What is claimed is:

1. A method for rewarding a customer comprising the steps of:
establishing an account for said customer;
awarding points to said customer account based on customer purchases;
inviting said customer to attend an event at a particular site; and
awarding additional points to said customer account when said customer attends said event.

2. A method according to claim 1, further comprising:
awarding bonus points to said customer account if said customer brings an individual to said event and said individual performs a particular act.

3. A method according to claim 2, wherein said bonus point awarding step occurs on-site at said event.

4. A method according to claim 2, wherein said particular act comprises applying for membership in a customer loyalty program.

5. A method according to claim 2, wherein said particular act comprises applying for a credit card.

6. A method according to claim 3, further comprising creating an account for said individual and awarding points to said individual's account after said individual has been approved.

7. A method according to claim 1, further comprising said account establishing step comprising providing said customer with a credit card to be used with said account and awarding further bonus points to said customer for charging purchases at said event using said credit card.

8. A method according to claim 1, further comprising providing special discounts to said customer at said event.

9. A method according to claim 1, further comprising conducting special programs at said event for said customer.

10. A method according to claim 9, wherein said special program conducting step comprises conducting family and youth activities.

11. A method according to claim 9, wherein said special program conducting step comprises conducting at least one seminar which said customer can attend.

12. A method according to claim 1, further comprising providing free transportation for said customer from a designated location to said site.

13. A method according to claim 1, further comprising providing special accommodation rates at a lodging facility for said customer.

14. A method according to claim 1, further comprising providing at least one special meal for said customer.

15. A method according to claim 1, further comprising providing a hospitality suite at said site for said customer.

16. A method according to claim 1, further comprising selecting said customer from a particular group of customers to receive an invitation to said event.

17. A method according to claim 16, wherein said selecting step comprises selecting said customer based on distance from the site of the event.

18. A method according to claim 16, wherein said selecting step comprises selecting said customer based on frequency of purchases.

19. A method according to claim 16, wherein said selecting step comprises selecting said customer based on a dollar value of goods purchased prior to the event.

20. A method according to claim 16, wherein said selecting step comprises selecting said customer based on a minimum number of transactions prior to the event.

21. A method according to claim 16, wherein said inviting step comprises forwarding said invitation to said selected customer via at least one of e-mail, facsimile, telephone and regular mail.

22. A method for rewarding customers enrolled in a customer loyalty program comprising the steps of:
selecting particular customers from said loyalty program; inviting said selected customers to attend an event at a particular site; and
awarding points to an account maintained by a particular one of said customers when said particular customer attends said event.

23. A method according to claim 22, wherein said point awarding step is performed on-site after said customer is identified at said event.

24. A method according to claim 22, wherein said selecting step comprises selecting those customers who reside within a certain distance from said site.

25. A method according to claim 22, wherein said selecting step comprises selecting customers who have made frequent purchases.

26. A method according to claim 22, wherein said selecting step comprises selecting customers who have exceeded a minimum level of purchases.

27. A method according to claim 22, wherein said selecting step comprises selecting customers who have completed a minimum number of transactions.

28. A method according to claim 22, further comprising:
awarding bonus points to an account of each said customer who brings another individual to said event.

29. A method according to claim 28, further comprising awarding bonus points to said another individual if said another individual opens an account by applying for membership in said loyalty program and is approved for membership.

30. A method according to claim 28, further comprising awarding bonus points to said another individual if said another individual applies for a credit card and is approved.

31. A method according to claim 22, further comprising providing said customer account with extra points if said customer makes a purchase at said event.
